(19) United States
(12) Patent Application Publication
(10) Pub. No.: US 2007/0178910 A1
(43) Pub. Date: Aug. 2, 2007

(54) Device for use in mobile terminals attached to a mobile communication network for processing data providing information on passenger transport means

(75) Inventors: Mohamed Adel Saidi, Antony (FR); Stephane Betge-Brezetz, Paris (FR); Gerard Delegue, Cachan (FR); Arnaud Gonguet, Paris (FR); Lionel Fournigault, Sur Yvette (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/516,778

(22) Filed: Sep. 7, 2006

(30) Foreign Application Priority Data
Sep. 8, 2005 (FR) 0552709

(51) Int. Cl. H04Q 7/20

(52) U.S. Cl. 455/456.1

(57) ABSTRACT

A device (D) for use in mobile communication terminals (T1-T3) attached to a mobile communication network (R) is dedicated to processing data providing information relating to passenger transport means (V21-V22). The device (D) comprises i) interface means (l1) adapted to exchange inquiries and response messages with mobile terminals and ii) processing means (MT) adapted, on receiving an inquiry for information on at least one station stop (S21-S25) served by transport means (V21-V22), to determine the geographical position of the enquiring mobile terminal (T1), then to determine a station stop (S23) as a function of that geographical position and one or more optimization criteria, and then to generate a response message to be sent to said enquiring mobile terminal (T1) that includes the coordinates of the station stop (S23) that has been determined.

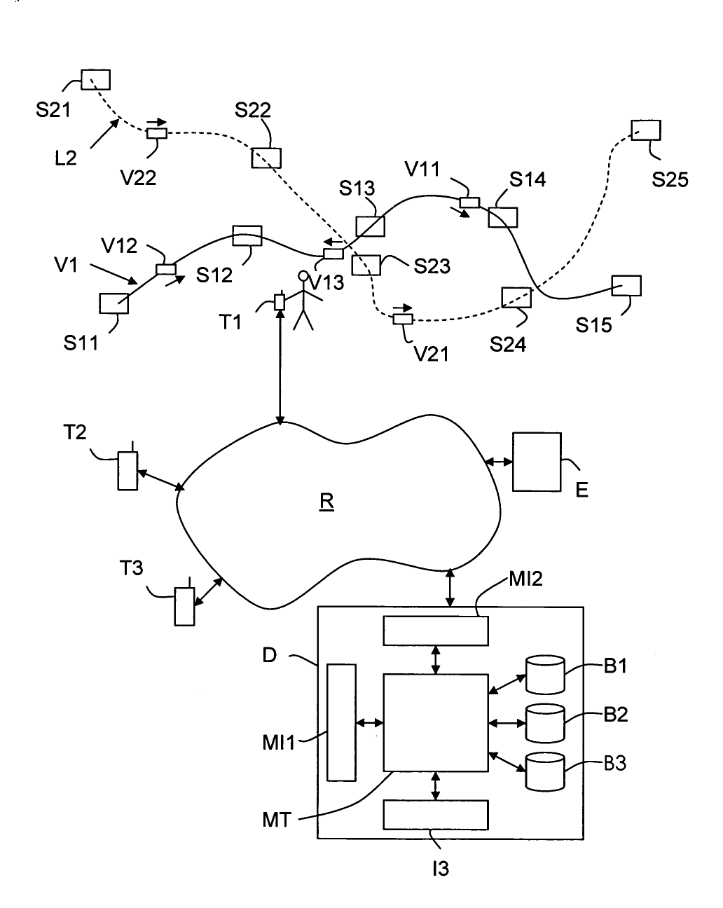

The invention relates to mobile (or cellular) communication networks, and more precisely to the communication of information concerning transport means to mobile communication terminals attached to such a network.

Public transport companies provide transport means such as buses, metros, trams, river buses and taxis that follow routes (or lines), usually predetermined routes or lines, passing through passenger station stops.

Some of these companies use a fleet tracking system enabling them to tell with some accuracy the positions of their passenger transport means relative to the station stops on at least some of their lines. At the station stops of lines equipped for this purpose, these companies generally make available to their customers information relating to the estimated waiting time and/or some traffic problems or incidents. Some traffic information is sometimes available on the Internet site (or the telephone server) of the company.

However, this information is of a collective nature and does not answer some customer inquiries, in particular when customers do not have a telephone providing Internet access, are far from a place where traffic information is displayed or do not know where to find a station stop or the station nearest to their location at a given time that is the most appropriate for their requirements.

In these situations, to attempt to obtain the information that he is looking for, the customer must go to a station stop or attempt to find one if he does not know the district. If he cannot obtain the required information where he is and if the traffic on the line serving the station stop to which he has made his way is restricted, or even interrupted, for example because of an incident or traffic congestion, he is then obliged to wait, even though the traffic may be normal (or less restricted) on another line, sometimes another line that is close by.

Thus, an object of the invention is to improve upon the above situation by enabling persons having a mobile communication terminal to obtain individual and collective information on passenger transport means related to their location at a given time.

To this end it proposes a device for use in mobile communication terminals attached to a mobile communication network to process data providing information relating to passenger transport means.

The device is characterized in that it comprises:
interface means adapted to exchange inquiries and response messages with mobile terminals, and
processing means adapted, on receiving an inquiry for information on at least one station stop served by transport means, to determine the geographical position of the enquiring mobile terminal, then to determine a station stop as a function of that geographical position and one or more optimization criteria, and then to generate a response message to be sent to said enquiring mobile terminal that includes the coordinates of the station stop that has been determined.

The processing device of the invention may have other features, and in particular, separately or in combination:
its processing means may be adapted to use an optimization criterion of the proximity criterion type to determine the station stop whose geographical position is nearest to the geographical position of the enquiring terminal;
its processing means may be adapted to use a first optimization criterion of the proximity criterion type and then a second optimization criterion of the station waiting time criterion type to determine each station stop whose geographical position is at a distance from the geographical position of said enquiring terminal below a selected threshold, and then to determine, of the station stops that have been determined, those at which the associated transport means should arrive within a time period within a selected time interval, and then, if there is at least one station stop satisfying both criteria, to select that which is nearest the geographical position of the enquiring terminal and, if there is no station stop satisfying both criteria, to determine a station stop whose geographical position is nearest to the geographical position of the enquiring terminal;
its processing means may instead be adapted to use a first optimization criterion of the proximity criterion type and then a second optimization criterion of the station waiting time criterion type to determine each station stop whose geographical position is at a distance from the geographical position of said enquiring terminal below a selected threshold and at which the associated transport means should arrive within a time period within a selected time interval, and then, if there is at least one station stop satisfying both criteria, to select that which is nearest the geographical position of the enquiring terminal and, if there is no station stop satisfying both criteria, to determine a station stop whose geographical position is nearest to the geographical position of the enquiring terminal;
its processing means may be adapted to define said threshold and/or said time interval as a function of information contained in said inquiry;
its processing means may be adapted to determine the required station stop as a function of a destination and/or a line of the transport means and/or a direction on a line served by transport means and/or at least one type of transport means contained in the inquiry;
its processing means may be adapted to access first storage means for storing first data representing the geographical positions of the passenger transport means and second storage means for storing second data representing at least geographical positions of the station stops at which said passenger transport means should stop in order to determine third data representing the estimated times of arrival of the passenger transport means in the selected station stops;
it may comprise said first storage means and/or said second storage means;
its processing means may be adapted to interrogate at least one external unit in order to receive said first data and to store that first data in said first memory means or its first storage means may be supplied with updated first data by at least one external unit;
its processing means may be adapted to interrogate at least one external unit in order to receive said second data and to store that second data in said second storage means or its second storage means may be supplied with updated second data by at least one external unit;
it may comprise third storage means adapted to store the third data in which case its processing means may be adapted to store the third data in the third storage means after determining it;
its processing means may be adapted to determine the third data as a function of fourth data representing traffic information and/or predefined timetables;
its processing means may be adapted to interrogate at least one external unit in order to receive the fourth data and to store that fourth data in the second storage means or its second storage means may be supplied with updated fourth data by at least one external unit;
its processing means may be adapted to integrate into the response message third data representing the estimated time of arrival of the passenger transport means in the station stop that has been determined;
its processing means may be adapted, in the event of an inquiry seeking additional information relating to selected transport means, to determine second and/or third data representing the additional information in order to integrate it into the response message;
its interface means may be adapted to receive any type of inquiry and to send any type of response message, where applicable corresponding to the type of inquiry sent.

Other features and advantages of the invention will become apparent on reading the following detailed description and examining the appended drawing in which the single figure is a diagram of two public transport lines and a portion of a mobile communication network to which are connected mobile communication terminals, external information units and one embodiment of a processing device of the invention. The appended drawing constitutes part of the description of the invention as well as contributing to the definition of the invention, if necessary.

An object of the invention is to enable mobile communication terminals attached to the mobile communication network to obtain in real time individual and collective information relating to passenger transport means.

It is considered hereinafter by way of nonlimiting example that the mobile communication terminals are mobile (or cellular) telephones capable of exchanging messages, for example SMS (Short Message Service) type messages, MMS (Multimedia Messaging Service) type messages, WAP (Wireless Application Protocol) type messages, electronic mail (e-mail) type messages or HTML page type messages, with a remote communication unit via one or more mobile or cellular networks that are preferably connected to the Internet. However, the invention is not limited to that application. It relates to all mobile (or cellular) communication terminals and in particular portable computers, personal digital assistants (PDA) and card telephones (also known as “smart phones”).

As shown diagrammatically in the single figure, the invention proposes to make available to one or more mobile networks one or more devices D dedicated to processing data representing information relating to passenger transport means belonging to one or more public transport companies.

In the present example, the irregular shape R represents mobile networks to which mobile terminals Ti are attached, the Internet and private networks, for example private networks belonging to public transport companies, all of which are connected to each other.

In the present example, the suffix i takes values from 1 to 3 (T1 to T3), but it may take any value greater than or equal to one (1).

It is important to note that a device D of the invention may be dedicated exclusively to information provided by a single transport company (as in the present example) or to information provided by a plurality of transport companies. If there is a plurality of devices D, mobile network customers must select a device to interrogate as a function of the type of transport means for which they are seeking information. In this case, an Internet portal dedicated to all of the devices may be provided to facilitate obtaining information.

Each device D may be connected to a mobile network, to the Internet or to a private network.

A processing device D comprises a first interface module Ml1 and a processing module MT.

The first interface (or customer interface) module Ml1 is a multitype communication interface capable of exchanging inquiries and response messages of all the types cited above with mobile terminals T attached to the network R (which here comprises their parent mobile network(s)).

In other words, this interface supports all communication channel types (including SMS, MMS, WAP, electronic mail, HTML and voice). It can therefore convert requests for information sent by the enquiring mobile terminals Ti into data understandable by the processing module MT and, conversely, convert response data generated by the processing module MT into response messages understandable to the enquiring mobile terminals Ti.

It is important to note that a response message is not necessarily of the same type as the inquiry to which it responds. A mobile terminal Ti sending a device D an SMS or electronic mail type inquiry and the device D responding to that inquiry by sending the mobile terminal Ti a voice response message (using a voice server) may be envisaged.

By default, and in the absence of information to the contrary in an inquiry, the response message type is preferably identical to the corresponding inquiry type. For the types to be different, it is preferable for the customer using the enquiring mobile terminal Ti to specify this in his inquiry.

The processing module MT intervenes each time that the first interface module Ml1 communicates to it the (converted) content of an inquiry for information regarding one or more station stops Sjk served by transport means Vjm of a company received from an enquiring mobile terminal Ti. More precisely, it determines the geographical position of the enquiring mobile terminal Ti, determines a station stop as a function of that geographical position and one or more optimization criteria, and finally generates response data to be sent to the enquiring mobile terminal Ti, via the first interface module l1 and over the networks R, in the form of a response message including at least the coordinates of the station stop that has been determined.

The geographical position of an enquiring mobile terminal Ti is obtained from its mobile network. As the person skilled in the art is aware, mobile networks can determine with relatively good accuracy the geographical positions of the mobile terminals that are attached to them and store data representing those geographical positions in a database such as an HLR (Home Location Register), for example.

The processing module MT is therefore adapted to generate requests sent to mobile networks to obtain the geographical positions of the enquiring mobile terminals Ti. To this end, as shown here, the device D may include a second interface (or mobile network interface) module Ml2 dedicated to exchanging geographical position inquiry and response messages between the processing module MT and the mobile networks.

Once the processing module MT is in possession of the geographical position of an enquiring mobile terminal Ti, it determines the most appropriate station, allowing for any information contained in the inquiry that it sent.

Using elementary inquiries generated automatically on entering a telephone number or e-mail address and requesting the device D to determine an “optimum” station, independently of the required destination, may be envisaged. This is particularly appropriate for finding a taxi rank and for persons who are completely unfamiliar with the transport networks of a town.

Using inquiries that include specific information, for example a destination and/or a transport line (with or without a destination) and/or a type of transport means, may also be envisaged. Generating this type of inquiry necessitates the enquiring customer entering the specific information on the mobile terminal Ti.

The processing module MT can use various optimization criteria.

Thus, the processing module MT may use a proximity criterion type optimization criterion. In this case, it determines the station stop Sjk whose geographical position is nearest to the geographical position of the enquiring terminal Ti, independently of the geographical positions of the transport means that must (or may) stop at the station stops Sjk. It must be remembered that the optimum stations are determined from the station stops Sjk of the company or companies to which the device D is dedicated.

Of course, when an inquiry contains specific information, the optimum station is determined from a restricted number of station stops determined by said specific information.

The data representing the geographical positions of the station stops Sjk of the companies and the data representing the definitions of any predetermined lines (or routes) followed by the transport means Vjm of a company are supplied by said companies. That data is preferably stored in storage means B1 of the device D, which may take any form, for example a company memory or a company database (as is the case hereinafter).

The company database B1 may be fed with data directly by an external unit E belonging to the company concerned, for example each time that an update is effected, or by the processing module MT after it has obtained the data from an external unit E belonging to the company concerned (the data may be obtained periodically, for example). The external unit is part of the private network of the company, for example, or is attached to the Internet.

In either case, if the processing module MT must determine an optimum station Sjk, it accesses the company database B1 to extract data that defines the station stops Sjk on which its determination must be based (all of them or a subset of them restricted by specific information contained in the inquiry).

The processing module MT may also use a proximity criterion type optimization criterion and a station waiting time criterion type optimization criterion. For example, the proximity criterion consists in determining all the station stops Sjk whose geographical positions are at a distance from the geographical position of the enquiring mobile terminal Ti below a selected threshold and the station waiting time criterion consists in determining all the station stops Sjk at which the associated transport means Vjm must (or may) stop within a time period that lies inside a chosen time interval. The station waiting time criterion is intended to optimize the choice of the recommended station stop by limiting the customer waiting time. It may be preferable to propose a station a little further away, in which the waiting time will be short, rather than to propose a station in which there is a risk that the waiting time will be (very) long.

The threshold and/or the time interval may be predefined and therefore fixed. However, they may equally be defined or adapted by the processing module MT as a function of specific information contained in the inquiry.

The processing module MT may first determine the station stops Sjk that satisfy the proximity criterion and then apply the station waiting time criterion to them.

The processing module MT may instead determine all the station stops Sjk that satisfy the proximity criterion (which gives a first subset) and all the station stops Sjk that satisfy the station waiting time criterion (which gives a second subset), after which it looks for an intersection (i.e. stations common to the first and second subsets) in an attempt to obtain at least one station stop satisfying both criteria.

If at least one station stop satisfies both criteria, the processing module MT gives preference to selecting that which is nearest to the geographical position of the enquiring mobile terminal Ti.

On the other hand, if no station stop meets both criteria, the processing module MT preferably determines the station stop whose geographical position is nearest to the geographical position of the enquiring mobile terminal Ti independently of the waiting time.

Of course, if an inquiry contains specific information, the optimum station is determined from a restricted number of station stops that is determined by said specific information.

As indicated above, the data representing the geographical positions of the station stops Sjk of the companies is preferably stored in the company database B1, which the processing module MT can access to determine each station stop Sjk satisfying the first criterion or that nearest to it (in the case of an empty intersection).

The data representing the geographical positions of the transport means Vjm that pass through the station stops Sjk of the companies is supplied by said companies. That position data is preferably stored in storage means B2 of the device D, which may take any form, for example a position memory or a position database (as is the case hereinafter).

This position database B2 may be fed with data directly by an external unit E belonging to the company concerned, for example each time that an update is effected, or by the processing module MT after it has obtained the data from an external unit E belonging to the company concerned (the data is obtained periodically, for example). The companies must of course have means for tracking their transport means Vjm able to supply them with the respective geographical positions. The unit E that supplies the position data may be the same as that which provides the company data, as in the present non-limiting example.

In either case, to facilitate transferring the position data from the external unit E to the device D, the latter may include a dedicated third interface module 13, as in the present nonlimiting example.

Moreover, in either case, if the processing module MT must determine an optimum station Sjk satisfying the station waiting time criterion, it may first access the position database B2 to extract the data that defines the geographical positions of the transport means Vjm concerned. The processing module MT then estimates the time necessary for each of the transport means Vjm concerned to reach the station stops Sjk concerned and therefore their estimated times of arrival at the latter. To estimate these times of arrival, the processing module MT must compare the geographical positions of the transport means Vjm concerned to the geographical positions of the corresponding station stops Sjk, the data representing which is stored in the company database B1, for example. This comparison preferably takes account of data representing traffic information and/or timetables.

The data representing traffic data and/or timetables is preferably stored in the company database B1. It may be provided directly by an external unit E belonging to the company concerned, for example each time that an update is effected, or by the processing module MT after it has obtained the data from an external unit E belonging to the company concerned (the data is obtained periodically, for example). The external unit E that supplies the traffic data may be the same unit that provides the company data, as in the present nonlimiting example.

In a variant intended to optimize the time taken to determine an optimum station, the processing module MT determines data representing the estimated times of arrival of the transport means Vjm at the various station stops Sjk at which they must (or may) stop, for example periodically or each time that the position database B2 is updated. To do this it proceeds as indicated above, by accessing the position database B2 and the company database B1 (preferably taking into account traffic data and/or timetable data).

The processing module MT then stores this data representing the estimated times of arrival in the storage means B3 of the device D, which may take any form, for example a time of arrival memory or a time of arrival database (as is the case hereinafter).

In this case, when it must determine an optimum station, the processing module MT has only to access the time of arrival database B3 to determine the times of arrival of the transport means Vjm at the station stops Sjk concerned.

Once the processing module MT has determined the station stops that satisfy the proximity criterion and the times of arrival of the transport means Vjm at the station stops Sjk concerned, it can determine the optimum station for the enquiring mobile terminal Ti using either of the methods described above.

Once the processing module MT has determined an optimum station for an enquiring mobile terminal Ti, it generates response data representing at least its coordinates (or address), which the first interface module Ml1 integrates into a response message sent to said enquiring mobile terminal Ti. The coordinates may be accompanied by the waiting time for the transport means Vjm.

A response message may also include additional information to respond to other inquiries contained in a customer inquiry, for example relating to the station stops of a transport line and/or the transport means and/or predefined timetables and/or the companies and/or fares and/or a type of destination (restaurants, leisure centers, cinemas, theatres, museums, concert halls and the like).

Three nonlimiting examples of the use of the device D of the invention are described next with reference to the single figure.

In these three examples, it is considered that a single company operates two (bidirectional) metro lines L1 and L2 (or Lj, where j=1 or 2) and that each of the lines Lj has five station stops Sj1 to Sj5 (or Sjk, where k=1 to 5) at which there may stop, at a given time, metros Vjm (V11 to V13 (m=1 to 3) in the case of the line L1 and V21 and V22 (m=1 or 2) in the case of the line L2).

In the first example, the processing module MT applies only one optimization criterion of the proximity criterion type.

The customer uses a terminal T1 to send the device D an elementary inquiry to find out which station is nearest to him (and thus an inquiry with no specific additional information).

When the first interface module Ml1 receives the inquiry from the mobile terminal T1, for example in the form of an SMS message, it forwards its content to the processing module MT. The latter generates an inquiry that is sent to the mobile network to which the mobile terminal T1 is attached in order for it to send it the geographical position of said mobile terminal T1. The processing module MT then accesses the company database B1 to determine the geographical positions of the stations Sjk on the lines L1 and L2. It then compares those geographical positions with the geographical position of the mobile terminal T1 sent by the mobile network R in order to determine which one is nearest to said mobile terminal T1 (i.e. it applies the proximity criterion). In the example shown, this is the station S23 on the second line L2. Finally, the processing module MT generates response data representing the coordinates of the station S23, which the first interface module Ml1 forwards to the mobile terminal T1 in the form of a response message, for example of the SMS or voice message type.

In the second example, the processing module MT applies a first optimization criterion of the proximity criterion type and then a second optimization criterion of the station waiting time criterion type.

The customer uses a terminal T1 to send the device D an elementary inquiry to find out which station is nearest to him (and thus an inquiry with no specific additional information).

In this case, when the first interface module Ml1 receives the inquiry from the mobile terminal T1, for example in the form of an electronic mail (e-mail) message, it forwards its content to the processing module MT, which generates an inquiry that is sent to the mobile network R to which the mobile terminal T1 is attached in order for it to send it the geographical position of said mobile terminal T1. The processing module MT then accesses the company database B1 in order to determine the geographical positions of the stations Sjk on the lines L1 and L2. It then determines the distances between those stations Sjk and the mobile terminal T1 and compares those distances to a selected threshold in order to retain the stations Sjk that correspond to a distance below the selected threshold (i.e. it applies the proximity criterion). The stations S12, S13, S22 and S23 are retained, for example. It then looks up in the time of arrival database B3 the estimated times of arrival of the metros Vjm in the station S12, S13, S22 and S23 that have been retained. From those stations, it then selects the station(s) corresponding to a time of arrival in the selected time interval (i.e. it applies the station waiting time criterion). For example, the stations selected are S12 (the metros V12 and V13 should arrive soon at the station S12) and S22 (the metro V22 should arrive soon at the station S22). The processing module MT then selects as the optimum station the one that is nearer to the mobile terminal T1. Here this is the station S12 on the first line L1. Finally, the processing module MT generates response data representing the coordinates of the station S12, which the first interface module l1 sends to the mobile terminal T1 in the form of a response message, for example of the electronic mail or voice message type.

In the third example, the processing module MT applies a first optimization criterion of the proximity criterion type and then a second optimization criterion of the station waiting time criterion type. However, the client uses a terminal T1 to send the device D an inquiry to find out the station that is nearest to him and from which he can travel to a destination X (i.e. an inquiry including specific additional information).

In this case, when the first interface module Ml1 receives the inquiry from the mobile terminal T1, for example in the form of an electronic mail (e-mail) message, it forwards its content to the processing module MT, which generates an inquiry to be sent to the mobile network R to which the mobile terminal T1 is attached in order for it to send it the geographical position of said mobile terminal T1. The processing module MT then accesses the company database B1 in order to determine the station that serves the destination X. This is the station S25 on the line L2, for example. The processing module MT then accesses the company database B1 again in order to determine the geographical positions of the stations S2k on the line L2. It then determines the distances between these stations S2k and the mobile terminal T1 and compares those distances to a selected threshold in order to retain the stations S2k corresponding to a distance below the selected threshold (i.e. it applies the proximity criterion). The stations retained are S22 and S23, for example. It then looks up in the time of arrival database B3 the estimated times of arrival of the metros V2m in the retained stations S22 and S23. From the retained stations, it then selects the station(s) corresponding to a time of arrival in the selected time interval (i.e. it applies the station waiting time criterion). For example, the stations selected are again S22 and S23 (the metro V22 should arrive soon in S22, then in S23). The processing module MT then selects as the optimum station the one that is nearest to the mobile terminal T1. Here that is the station S23 on the second line L2. Finally, the processing module MT generates response data representing the coordinates of the station S23 and indicating that the destination X is served by the station S25 (here the terminus of the second line L2), which the first interface module Ml1 sends to the mobile terminal T1 in the form of a response message, for example of the electronic mail or voice message type.

The processing device D of the invention, and in particular its first interface module Ml1 and its processing module MT, and where applicable its second and third interface modules Ml2, Ml3 and its first, second and third storage means B1, B2, B3, may take the form of electronic circuits, software (or electronic data processing) modules, or a combination of circuits and software.

The invention has many advantages, including:
it makes available to public transport company customers large amounts of information that were previously inaccessible,
it responds entirely automatically (without human intervention) to individual inquiries from customers relating to transport means accessible near their location,
it is easy to implement as it essentially requires a processing device D and connections to external units of public transport companies,
customers requiring information have to perform a minimum number of operations to generate an inquiry.

The invention is not limited to the processing device embodiments described hereinabove by way of example only and encompasses all variants that the person skilled in the art might envisage that fall within the scope of the following claims.

1. Device (D) for use in mobile communication terminals (Ti) attached to a mobile communication network (R) to process data providing information relating to passenger transport means (Vjm), characterized in that it comprises i) interface means (Ml1) adapted to exchange inquiries and response messages with mobile terminals (Ti) and ii) processing means (MT) adapted, on receiving an inquiry for information on at least one station stop (Sjk) served by transport means (Vjm), to determine the geographical position of the enquiring mobile terminal (Ti), then to determine a station stop as a function of that geographical position and one or more optimization criteria, and then to generate a response message to be sent to said enquiring mobile terminal (Ti) that includes the coordinates of the station stop that has been determined.

2. Device according to claim 1, characterized in that said processing means (MT) are adapted to use an optimization criterion of the proximity criterion type to determine the station stop (Sjk) whose geographical position is nearest to the geographical position of said enquiring terminal (Ti).

3. Device according to claim 1, characterized in that said processing means (MT) are adapted to use a first optimization criterion of the proximity criterion type and then a second optimization criterion of the station waiting time criterion type to determine each station stop (Sjk) whose geographical position is at a distance from the geographical position of said enquiring terminal (Ti) below a selected threshold, and then to determine, of the station stops that have been determined, those at which the associated transport means (Vjm) should arrive within a time period within a selected time interval, and then i) if there is at least One station stop (Sjk) satisfying both criteria, to select that which is nearest the geographical position of said enquiring terminal (Ti) and ii) if there is no station stop satisfying both criteria, to determine a station stop (Sjk) whose geographical position is nearest to the geographical position of said enquiring terminal (Ti).

4. Device according to claim 1, characterized in that said processing means (MT) are adapted to use a first optimization criterion of the proximity criterion type and then a second optimization criterion of the station waiting time criterion type to determine each station stop (Sjk) whose geographical position is at a distance from the geographical position of said enquiring terminal (Ti) below a selected threshold and at which the associated transport means (Vjm) should arrive within a time period within a selected time interval, and then i) if there is at least one station stop (Sjk) satisfying both criteria, to select that which is nearest the geographical position of said enquiring terminal (Ti) and ii) if there is no station stop satisfying both criteria, to determine a station stop (Sjk) whose geographical position is nearest to the geographical position of said enquiring terminal (Ti).

5. Device according to claim 2, characterized in that said processing means (MT) are adapted to define said threshold and/or said time interval as a function of information contained in said inquiry.

6. Device according to claim 3, characterized in that said processing means (MT) are adapted to define said threshold and/or said time interval as a function of information contained in said inquiry.

7. Device according to claim 4, characterized in that said processing means (MT) are adapted to define said threshold and/or said time interval as a function of information contained in said inquiry.

8. Device according to claim 1, characterized in that said processing means are adapted to determine the required station stop (Sjk) as a function of a destination and/or a line (Lj) of the transport means (Vjm) and/or a direction on a line (Lj) served by transport means (Vjm) and/or at least one type of transport means (Vjm) contained in said inquiry.

9. Device according to claim 1, characterized in that said processing means (MT) are adapted to access first storage means (B2) for storing first data representing the geographical positions of the passenger transport means and second storage means (B1) for storing second data representing at least geographical positions of the station stops (Sjk) at which said passenger transport means (Vjm) should stop in order to determine third data representing the estimated times of arrival of the passenger transport means (Vjm) in the selected station stops (Sjk).

10. Device according to claim 9, characterized in that it comprises said first storage means (B2) and/or said second storage means (B1).

11. Device according to claim 9, characterized in that said processing means (MT) are adapted to interrogate at least one external unit (E) in order to receive said first data and to store that first data in said first memory means (B2).

12. Device according to claim 10, characterized in that said processing means (MT) are adapted to interrogate at least one external unit (E) in order to receive said first data and to store that first data in said first memory means (B2).

13. Device according to claim 9, characterized in that said first storage means (B2) are supplied with updated first data by at least one external unit (En).

14. Device according to claim 10, characterized in that said first storage means (B2) are supplied with updated first data by at least one external unit (En).

15. Device according to claim 9, characterized in that said processing means (MT) are adapted to interrogate at least one external unit (E) in order to receive said second data and to store that second data in said second storage means (B1).

16. Device according to claim 9, characterized in that said second storage means (B1) are supplied with updated second data by at least one external unit (E).

17. Device according to claim 9, characterized in that it comprises third storage means (B3) adapted to store said third data and said processing means (MT) are adapted to store said third data in said third storage means (B3) after determining it.

18. Device according to claim 15, characterized in that it comprises third storage means (B3) adapted to store said third data and said processing means (MT) are adapted to store said third data in said third storage means (B3) after determining it.

19. Device according to claim 9, characterized in that said processing means (MT) are adapted to determine said third data as a function of fourth data representing traffic information and/or predefined timetables.

20. Device according to claim 19, characterized in that said processing means (MT) are adapted to interrogate at least one external unit (E) in order to receive said fourth data and to store that fourth data in said second storage means (B1).

21. Device according to claim 19, characterized in that said second storage means (B1) are supplied with updated fourth data by at least one external unit (E).

22. Device according to claim 9, characterized in that said processing means (MT) are adapted to integrate into said response message third data representing the estimated time of arrival of the passenger transport means in said station stop that has been determined.

23. Device according to claim 20, characterized in that said processing means (MT) are adapted to integrate into said response message third data representing the estimated time of arrival of the passenger transport means in said station stop that has been determined.

24. Device according to claim 9, characterized in that said processing means (MT) are adapted, in the event of an inquiry seeking additional information relating to selected transport means (Vjm), to determine second and/or third data representing said additional information in order to integrate it into said response message.

25. Device according to claim 1, characterized in that said interface means (l1) are adapted to receive any type of inquiry and to send any type of response message.
